(19) United States
(12) Patent Application Publication
(10) Pub. No.: US 2011/0010747 A1
(43) Pub. Date: Jan. 13, 2011

(54) METHOD AND SYSTEM FOR CUSTOMIZED INITIALIZATION OF DIGITAL HOST DEVICE

(75) Inventors: Victor K. Liang, Irvine, CA (US); Ho Suk Chung, Rancho Palos Verdes, CA (US); Fei Xie, Irvine, CA (US)

Correspondence Address: Myers Andras Sherman & Zarrabian LLP;(Samsung R&D Center), 1411 5th Street, Suite 306, Santa Monica, CA, 90401, US

(73) Assignee: Samsung Electronics Co., Ltd., GYEONGGI-DO (KR)

(21) Appl. No.: 12/501,369

(22) Filed: Jul. 10, 2009

(51) Int. Cl. H04N 7/173

(52) U.S. Cl. 725/116; 725/131

(57) ABSTRACT

A method and system for customizing an interactive cable host initialization process for a cable host device, is provided. One implementation involves triggering an interactive cable host initialization process for a cable host device, detecting a initialization stage event for the cable host device and providing initialization stage event notification, and dynamically receiving content determined by a Multiple Service Operator (MSO) cable headend based on the initialization stage event notification over a network.

### FIELD OF THE INVENTION

The present invention relates generally to digital cable services, and in particular, to interactive technology for digital cable services over a cable video network.

### BACKGROUND OF THE INVENTION

The OpenCable initiative, managed by CableLabs, began in 1997 with the goal of helping the cable industry deploy interactive cable services and create competition in the host device marketplace. OpenCable Application Protocol (OCAP) is a middleware software layer intended to enable development of interactive television services and applications that run successfully on any cable television (TV) system in North America, independent of set-top boxes or television receiver hardware or operating system software choices. OCAP enables manufacturers of set-top boxes, televisions, and other devices to provide to consumers devices that support services delivered by cable operators to consumers previously only available via lease Set-Top-Boxes from cable operators.

A boot-up process for an OCAP TV involves a long process (approximately 15 to 45 minutes) having multiple stages, wherein each stage may have different requirements depending on Multiple Service Operator (MSO) needs. MSO is an operator of multiple cable television systems network or headend. Due to the lengthy process, there is ongoing research into methods for display of installation status and progress information on the TV screen during boot-up to avoid a blank TV screen.

There are two types of boot processes defined in the OCAP specification. One boot process involves a Security Element, and another boot process does not involve a Security Element. A Security Element, as currently defined in the current OpenCable specification, is a CableCARD device. However, a TV without the CableCARD will not function fully as a cable MSO host, and OCAP will have limited use. A boot-up process with CableCARD present is a primary scenario which involves a first time TV boot-up in an OCAP cable network environment.

Typical boot-up stages with CableCARD present in the TV may include: Power_applied, Hardware/OS_Initialization, Initialization_of_OCAP_environment, CableCard/Host_Interface_Initialization, Code_download, Load/Parse_XAIT, Configure_environment, Launch_Initial_Monitor_Application, Launch_Unbound_application, and Begin_Normal_Operation. Depending on different stage events, current TV boot-up scheme display information pre-stored in the TV for display during boot-up.

The preparation and storage of these messages is a burden for TV manufacturers and is not flexible because of the difficulty to update in the future. Further, the messages cannot be customized to meet different MSO requirements. Thus, existing OCAP TV boot-up implementations are tightly bound to MSO-specific needs and are highly MSO-dependent. Customization to each MSO/cable network causes not only additional burden for TV manufacturers but also inflexibility to customers and MSOs as well.

### BRIEF SUMMARY OF THE INVENTION

A method and system for customized initialization of digital host device, is provided. One embodiment comprises a customized interactive initialization process including triggering an interactive host initialization process for the digital host device, wherein the initialization process including multiple stages. The customized interactive initialization process further includes detecting an initialization stage event for the host device, and providing an initialization stage event notification, and dynamically receiving content determined by a service provider, over a network based on the initialization stage event notification.

Another embodiment comprises customized interactive initialization involving an initialization process for a host device including a digital cable receiver, wherein cable services are delivered to the digital cable receiver over a cable network. In one implementation, a method of customizing an interactive cable host initialization process for a cable host device, comprises triggering an interactive cable host initialization process for a cable host device, detecting an initialization stage event, and providing an initialization stage event notification. Upon notification of a specified initialization stage event, triggering dynamic delivery of content determined by an Multiple Service Operator (MSO) headend for the initialization event. Then, dynamically receiving content determined by the Multiple Service Operator (MSO) headend over a network based on the boot stage event notification. The customized initialization may further comprise presenting content received based on each initialization stage event notification, wherein received content is dynamically displayed at different initialization stages.

Customized initialization may further comprise maintaining a predefined set of initialization stage events and associated content determined by the service provider; upon notification of a specified initialization stage event, selecting an associated content; dynamically receiving the selected content from a content source over a network; and presenting the received content via the cable host receiver device for the initialization event.

These and other features, aspects and advantages of the present invention will become understood with reference to the following description, appended claims and accompanying figures.

### BRIEF DESCRIPTION OF THE DRAWINGS

FIG. 1 shows a block diagram of a system implementing dynamic customization of initialization process for a cable device host, according to an embodiment of the invention.

FIG. 2 shows a block diagram detailing an example implementation of the system of FIG. 1, according to an embodiment of the invention.

FIG. 3 shows a flowchart for dynamic customization of initialization process for an OCAP host, according to an embodiment of the invention.

FIG. 4 shows an example flowchart of a typical initialization process for an OCAP host.

FIG. 5 shows an event diagram for dynamic customization of initialization process for an OCAP host, according to an embodiment of the invention.

### DETAILED DESCRIPTION OF THE INVENTION

A method and system for customized initialization of digital host devices, is provided. One embodiment comprises a customized interactive initialization process including triggering an interactive host initialization process for the digital host device, wherein the initialization process including multiple stages. The customized interactive initialization process further includes detecting an initialization stage event for the host device, and providing an initialization stage event notification, and dynamically receiving content determined by a service provider, over a network based on the initialization stage event notification. The content may be delivered by said service provider itself, or by another service provider.

One implementation comprises customized interactive initialization involving a boot-up process for an electronic host device including a digital cable receiver, wherein cable services are delivered to the digital cable receiver over a cable network. The customized interactive initialization may comprise other processes which are enabled as customized interactive processes according to embodiments of the present invention. The host device may comprise consumer electronics devices (e.g., TVs, Set-Top-Boxes).

The customized initialization is applicable to OpenCable Application Platform (OCAP) and to tru2way technology (based on OCAP), and in particular, to improving efficiency of tru2way digital cable host devices. Such host devices may comprise digital cable receivers, such as televisions (TVs) or Set-Top-Boxes (STBs). In this description, the terms tru2way and OCAP refer to the same technology and are used interchangeably.

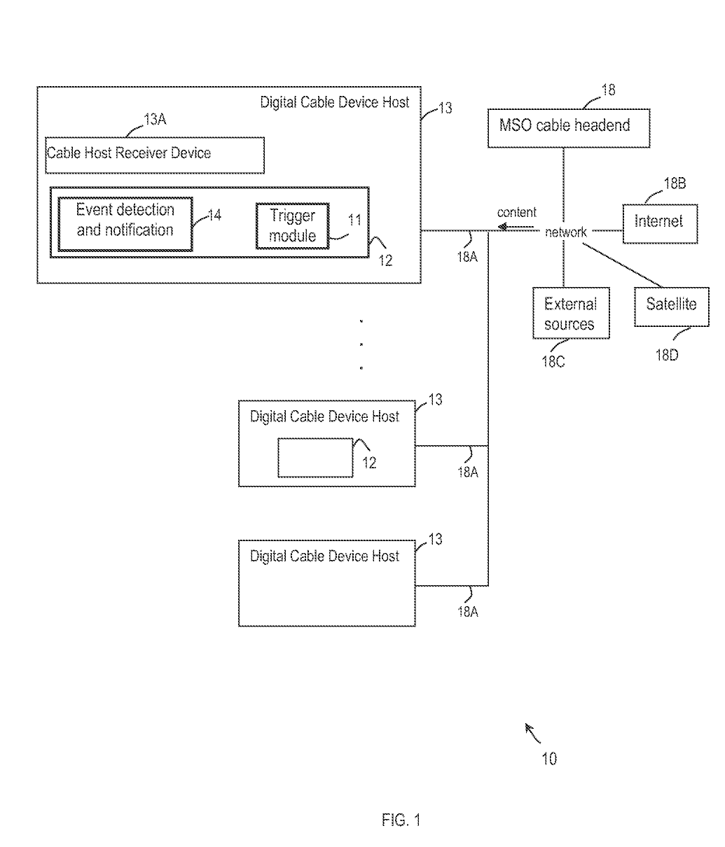

Referring to FIG. 1, a system 10 according to an embodiment of the invention implements customized initialization providing an interactive boot-up process for initialization of a cable host device 13. The cable host device 13 comprises a cable host receiver device 13A, wherein customized initialization is enabled by a customization system 12. The system 10 further includes a communication line for communication with an Multiple Service Operator (MSO) cable headend 18.

A method of customizing an interactive cable host boot process for the cable host device comprises: triggering an interactive cable host boot-up process for the cable host device, detecting a boot-up stage event, and providing event notification. Upon notification of a specified boot-up event, triggering dynamic delivery of content from a content source determined by the MSO headend for the boot-up event. Then, dynamically receiving content determined by the MSO headend based on the boot stage event notification. The customized initialization further comprises presenting content received based on each event notification, wherein received content is dynamically displayed at different boot-up stages.

The content may comprise video, still images, text, graphics, etc., which may be delivered to the cable host device at various stages of the boot-up process. Delivering the content may comprise channel force tune, internet connections or other pipes such as DOCSIS Set-top Gateway (DSG), to retrieve such content. The delivery network may include one or more of a cable network 18A, Internet 18B, external sources 18C (e.g., data bases, servers, etc.), satellite-based 18D. The content may be delivered by the MSO headend itself, or by another service provider (e.g., Internet 18B, external sources 18C). Further, although in the examples below the MSO 18 is provided as determining content for each initialization stage, the invention is further applicable to other entities 18B, 18C, 18D, performing the role of the MSO 18.

In one embodiment, the customization system 12 comprises a trigger module 11 and an event detection and notification module 14. The customization system 12 customizes an interactive cable host boot process for the cable host device 13. In one embodiment, the trigger module 11 triggers an interactive cable host boot-up process for the cable host device 13. The detection and notification module 14 detects a boot-up stage event and provides event notification. The trigger module 11 obtains tuning information based on the boot stage event notification. The trigger module 11 then performs channel tuning based on the tuning information to display video content from a Multiple Service Operator (MSO) headend over a cable network to the cable host device 13 based on each boot-up stage event notification. As such, video content is dynamically displayed at different boot-up stages.

Specifically, the event detection and notification module 14 detects OCAP boot-up process stage events (boot-up stage events or boot-up events) and notifies the trigger module 11 of such events. Upon detection of a specified boot-up stage event notification, the trigger module 11 initiates the download process of MSO-specific content associated with the boot-up stage event. A boot-up stage event may come from multiple sources such as hardware, operating system, OCAP stack, CableCARD, XAIT signaling (or AIT if necessary), and applications (e.g., an invocation of a function/method call by an application may initiate an event notification). Trigger of audio/video display can also be performed automatically by the trigger module 11 or performed manually by a technician.

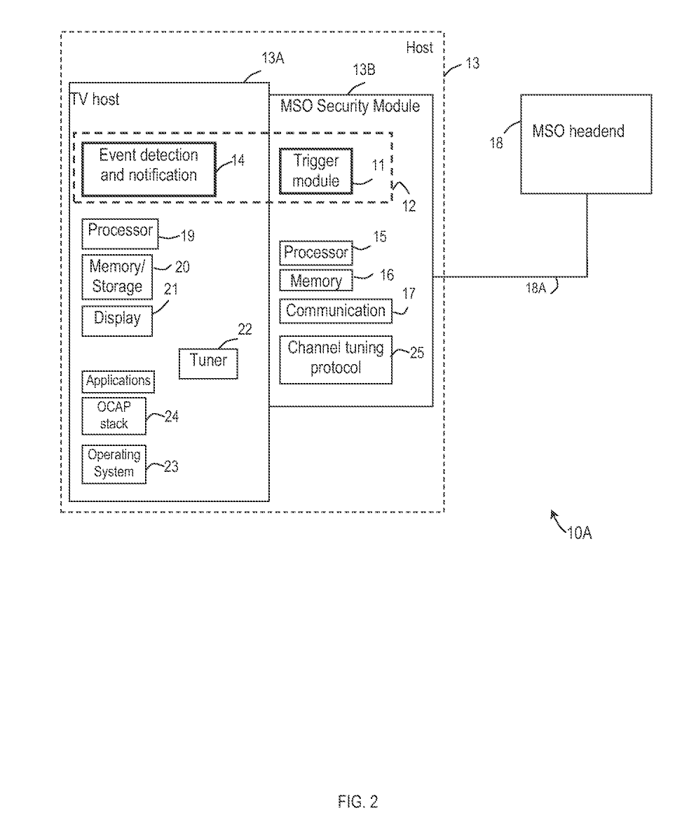

FIG. 2 shows a block diagram of a system 10A providing a detailed example implementation of the system of FIG. 1, according to an embodiment of the invention. The cable host device 13A comprises a cable TV host such as an OCAP TV host. The cable services are delivered over a cable network, allowing TV manufacturers to provide customized OCAP initialization processes in a Multiple Service Operator (MSO)-independent manner. This enables dynamic field modifiability for each MSO cable network. Although this example is directed to an OCAP TV host, the invention is equally applicable to other digital cable receivers. As used herein, initialization and boot-up are equivalent and include installation, set-up, boot sequence, reboot, etc.

The example customized initialization for a OCAP TV host 13A enables MSO independence by detection of boot-up stage event notification signals at each boot-up stage and enabling display of dynamic (e.g., real-time) information stream(s), such as video, from the MSO 18 over a network, during the OCAP TV boot-up procedure. This is instead of relying on pre-stored MSO-specific graphic images in the OCAP TV host 13A. The framework provides each MSO the ability to dynamically control the said information stream and content depending on the OCAP TV boot-up stage. As a result, each MSO may dynamically modify the displayed information during the OCAP TV boot-up process.

The framework allows an OCAP TV boot-up process to be MSO-independent and supports TV viewers to be aware of the boot-up process progressing in the background defined and customized by each MSO.

The example customized initialization allows OCAP TV boot-up processes to be MSO-independent while allowing TV viewers to be aware of the boot-up (including installation, set up, boot-up, reboot, etc.). This is also useful with television networking introduction, channel information, advertisement or for other purposes, during the lengthy boot-up process. As such, the customized initialization provides enhanced and customized user experience and flexibility for OCAP TV boot-up process, while eliminating the burden on a TV manufacturer to prepare customized pre-stored messages and graphics for each MSO network.

In FIG. 2, the cable host device 13 further comprises an MSO security module 13B (e.g., CableCARD) coupled to the OCAP TV. The host device 13 is connected to the MSO headend 18 using said communication link (e.g., via a cable video network). The security module 13B allows viewing of cable television channels without a set-top box. The security module 13B may comprise a plug-in card (e.g., PCMCIA card for the TV) which provides conditional access and copy protection functions that ensure content only available to subscribing users.

In the example shown in FIG. 2, the trigger module 11 is implemented in the MSO security module 13B, and the event detection and notification module 14 is implemented in the OCAP TV 13A. However, in another embodiment of the invention, the trigger module 11 may be implemented in the OCAP TV 13A, and the security module 13B may be absent. Yet, in another embodiment of the invention, the trigger module 11 may include two sub-modules, one sub-module implemented in the OCAP TV 13A and the other sub-module in the security module 13B.

The MSO security module 13B further includes a processor 15, a memory device 16 and a communication module 17 for communication with an MSO headend 18. The OCAP TV 13A further includes a processor 19, a memory device 20, a display module 21 and a TV channel tuner 22.

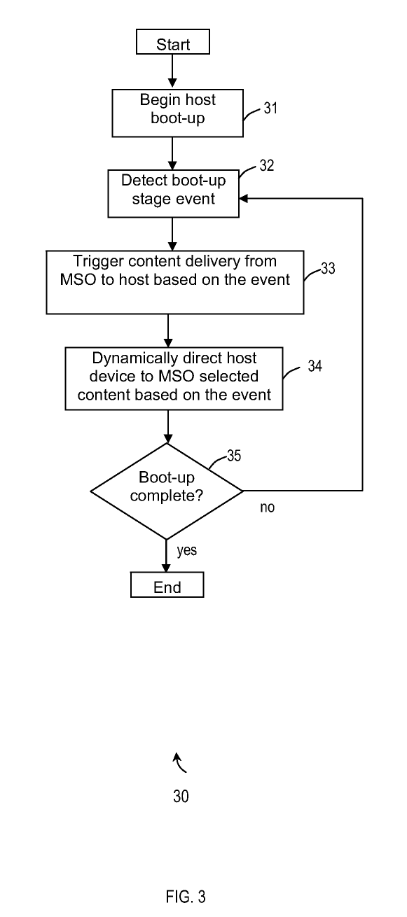

The boot-up process is managed by the customization system 12 which manages a process to display MSO-specific content such as video stream(s) on the TV display during the OCAP TV boot-up (or set up) sequences. FIG. 3 shows a process 30 for host boot-up procedure according to an embodiment of the customization system 12, comprising:
Block 31: Begin host boot-up.
Block 32: Detect boot-up stage event and notify.
Block 33: Trigger content delivery from MSO to host, based on the event notification.
Block 34: Dynamically direct host device to MSO selected content based on the event.
Block 35: Determine if boot-up complete? If not, proceed to block 32 to detect another boot-up stage event, otherwise end.

In one example, the trigger module 11 of the customization system 12 initiates an OCAP (e.g., tru2way) boot-up process according to an embodiment of the invention. The video stream may be associated with a certain stage within the boot-up process in an asynchronous or synchronous manner. Each stage may be signaled by the event detection and notification module 14 and detected by the trigger module 11. Upon notification of a specified event, the trigger module 11 triggers an automated display of video stream(s) received from the MSO headend 18 via a communication line 18A, on the display 21.

A predefined set of initialization events and associated MSO content (e.g., MSO cable channels) are maintained. The event detection and notification module 14 detects such predefined set of events. Upon a specified event notification, the trigger module 11 initiates the display of the content (e.g., video stream(s)) from the MSO 18, such as by force tuning the host 13 (e.g., OCAP TV host 13A) to a channel according to each event.

The event signal may be generated from multiple sources such as: hardware, operating system 23 (FIG. 2), OCAP stack 24 (FIG. 2), extended application information table (XAIT) standard signaling (or AIT if necessary) based on the OCAP, and applications (e.g., invocation of a function/process call by an application may initiate an event notification).

A different MSO-generated video stream may be associated to each host boot-up event, and upon detection of that event (XAIT signaling), the OCAP TV host 13A is dynamically forced to a linear channel or video on demand (VOD) type channel, provided by an MSO. For example, the trigger module 11 force tunes the OCAP TV host 13A to an MSO selected channel via tuner 22, to display the MSO-sourced audio/video content on the display 21.

The host device 13A may also be force tuned to a channel such as video on demand (VOD) type channel by an MSO field technician as well. The VOD-type channel allows synchronization of the boot process among multiple hosts when they boot at different times.

In an asynchronous approach, after two-way communication between the MSO headend 18 and the host 13 has been established, the VOD-type video stream is approximately synchronized with the current host boot-up process. In a synchronous approach, the VOD-type video stream is precisely synchronized with the current host boot-up process, wherein the host directly or indirectly provides boot-up event notifications to the headend 18.

Table 1 below illustrates an example of events at different stages of OCAP TV boot-up process.

TABLE 1
boot-up stages and events

| Step # | Stage | Possible Event/Module |
|---|---|---|
| 41 | Power Applied | |
| 42 | Hardware/OS Initialization | |
| 43 | Search Card mode | |
| 44 | Search DSG/OOB channel | |
| 45 | Initial CH map data retrieval | OOB SI manager |
| 46 | All type of CH map data | OOB SI manager |
| | retrieving | |
| 47 | CH map complete | OOB SI manager |
| 48 | XAIT downloading | MSO security module |
| 49 | 2 Way Established | eCM, MSO security module |
| | | or DSG M/W |
| 50 | Host IP retrieval | MSO security module |
| 51 | SI download | OOB SI manager |
| 52 | Initial Monitor download | XAIT with Priority 255 |
| 53 | Initial Monitor verification | |
| 54 | Initial Monitor loading | |
| 55 | OCAP app download | XAIT with Priority 100~254 |
| 56 | OCAP app verification | |
| 57 | OCAP loading | |
| 58 | VOD Direct Tune | |

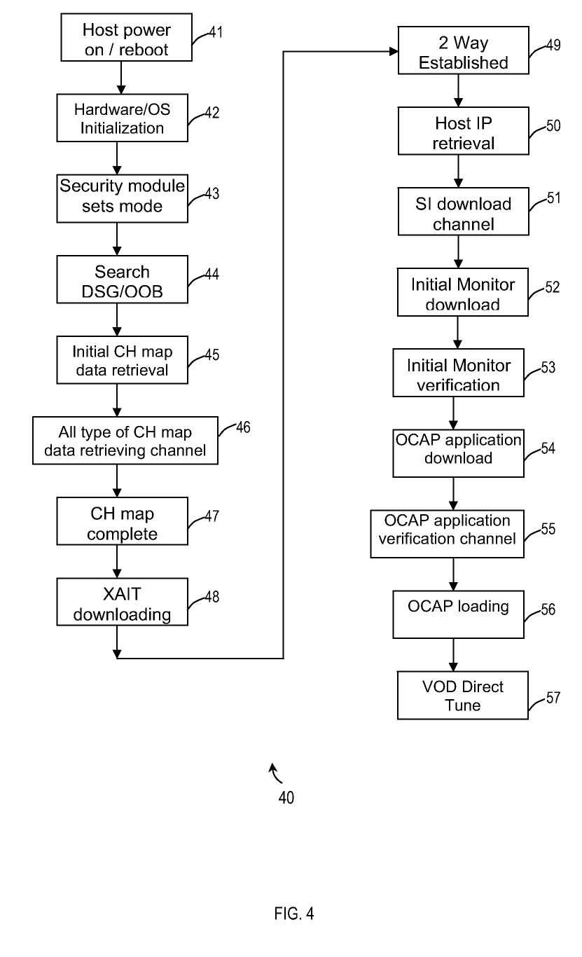

FIG. 4 shows an example boot-up process 40 based on Table 1, according to an embodiment of the invention. In block 41, the OCAP TV 13A (FIG. 2) is powered on or a reboot is initiated via a software application. In block 42, a low level initialization of the hardware and operating system of OCAP TV host 13A takes place. In block 43, during MSO security module initialization, the trigger module 11 proactively sends a setDSGmode( )Application Protocol Data Unit (APDU) to the OCAP TV host 13A to indicate that the trigger module 11 desires, for example, a MSO-specified linear channel. In block 44, searching DOCSIS Set-top Gateway (DSG)/Out Of Band (OOB) channel is performed. During blocks 41-44, the OCAP TV host 13A may not be able to receive any video stream from MSO due to lack of any Channel (CH) map information.

During blocks 45-47, an event for each host boot-up stage is utilized in OCAP OOB Service Information (SI) manager at the OCAP TV host 13A since all the traffic passes through the OOB SI manager. In block 48, an event can be implemented in the trigger module 11 when the OCAP TV host 13A receives a XAIT table from OOB or DSG broadcast tunnel from the MSO headend 18 (i.e., a stream of packets sent from a Cable Modem Termination System (CMTS) to a cable modem embedded in a set-top box or receiver). CMTS is a router which interfaces between Ethernet networks and radio frequency (RF) network connections to cable modems. An event for block 49 may involve the OCAP TV host 13A receiving a REGISTRATION_RESPONSE message from CMTS to embedded cable modem (eCM). Alternatively, an event for each boot-up stage may be utilized in the trigger module 11 or DSG middleware layer.

In block 50, an event for Host IP retrieval may exist in the trigger module 11, and for SI download in block 51 is OOB SI manager. In blocks 52-54, a Monitor application comprising a special unbound application with the highest possible priority is downloaded to the OCAP TV host 13A from the MSO headend 18. During this download in the boot-up stage (signaled through the XAIT event with Priority 255), the MSO headend 18 may transmit a video stream for display by the OCAP TV host 13A after XAIT signaling. During the download of the unbound applications in the boot-up process, signaled through the XAIT with Priority 100˜254, the MSO headend 18 may transmit a video stream after XAIT signaling for display by the OCAP TV host 13A. The video stream may be stored in the host 13A locally to avoid duplicative downloading of the same video stream. In block 55, application verification is performed. In block 56, OCAP stack is loaded, and in block 57 VOD direct tuning is performed. By using video stream(s) from each MSO, the streamed content is driven dynamically (e.g., in real time) by the MSO and as such customized for each MSO.

The customization process may force tune the OCAP TV host 13A to different channel(s) and display MSO-specific video stream(s) on the TV display 21 during the OCAP TV boot-up (e.g., set up, installation) sequences. This may be achieved by employing channel tuning and generic diagnostic protocols 25 (FIG. 2) of the security module 13B, to dynamically tune to different channels in different boot-up stages for displaying suitable MSO generated audio/video content (e.g., for installation guidance or other purposes). In that case, at the beginning of the boot-up process, when security module 13B is initiated, the trigger module 11 sends a Generic Diagnostic request to the OCAP TV host 13A, as currently defined in the CableCARD specification, but with a newly defined OCAP_bootup diagnostic identifier to request the OCAP_bootup_status according to the invention. The event detection and notification module 14 then responds with one or more boot-up status reports (OCAP_bootup_status) according to the invention, to provide information about the current boot-up stage in progress at the OCAP TV host 13A.

When the trigger module 11 receives a status report from the event detection and notification module 14, it initiates a channel force tune to the OCAP TV host 13A, with necessary tuning information such as channel frequency or a source ID, as defined in the Host Control protocols of the CableCARD specification. The OCAP TV host 13A then tunes to the selected channel via tuner 22 and displays the MSO-sourced audio/video content on the display 21 to the TV viewer. The tuned channel preferably provides suitable content associated with the boot-up stage in progress. The event detection and notification module 14 continues to provide the OCAP_bootup_status reports to the trigger module 11 as boot-up stages progress, wherein the trigger module 11 directs the OCAP TV host 13A to tune to different channels accordingly for streaming MSO content suitable to the boot-up stage to the OCAP TV host 13A for display.

By using video stream(s) from each MSO, the streamed content is driven dynamically (e.g., in real time) by the MSO and as such customized for each MSO. The video stream is dynamically provided by the MSO 18 and may be associated with a certain boot-up stage within the TV boot-up process in an asynchronous or synchronous manner.

In general, there may be multiple stages within the OCAP TV boot-up process, and an event may be defined for each stage. The trigger module 11 is configured to detect boot-up stage changes based on notifications from the detection and notification module 14 during the host boot-up process. The trigger module 11 then force-tunes the OCAP TV host 13A to MSO-specific content via the tuner 22 for display on the display 21.

According to CCIF 2.0 Section 9.2, resources allow encapsulating functionalities between the OCAP TV host 13A and the security module 13B. An embodiment of the invention may be implemented by modification/extension to one or more of such resources specified in OC-SP-CCIF2.0-116-081114. For the trigger module 11 to receive boot-up stage changes during the OCAP TV 13A boot-up process, a Generic Diagnostic Support Resource (9.16 of CCIF) may be used to request that the host 13A perform a diagnostic operation and report the status (e.g., boot-up process stage information) back to the trigger module 11. The Generic Diagnostic Support Resource comprises 2 APDUs as defined in Tables 2 and 3 below.

TABLE 2
Generic Diagnostic Support Resource

| Resource | Mode | Class | Type | Version | Identifier (hex) |
|---|---|---|---|---|---|
| Generic Diagnostic | S-Mode | 260 | 1 | 2 | 0x01040042 |
| Support | | | | | |
| Generic Diagnostic | M-Mode | 260 | 2 | 1 | 0x01040081 |
| Support | | | | | |

TABLE 3
Generic Diagnostic Support APDUs

| | | | Direction |
|---|---|---|---|
| APDU Name | Tag Value | Resource | Host [symbol] CableCARD |
| diagnostic_req( ) | 0x9FDF00 | Generic Diagnostic | ← |
| | | Support | |
| diagnostic_cnf( ) | 0x9FDF01 | Generic Diagnostic | → |
| | | Support | |

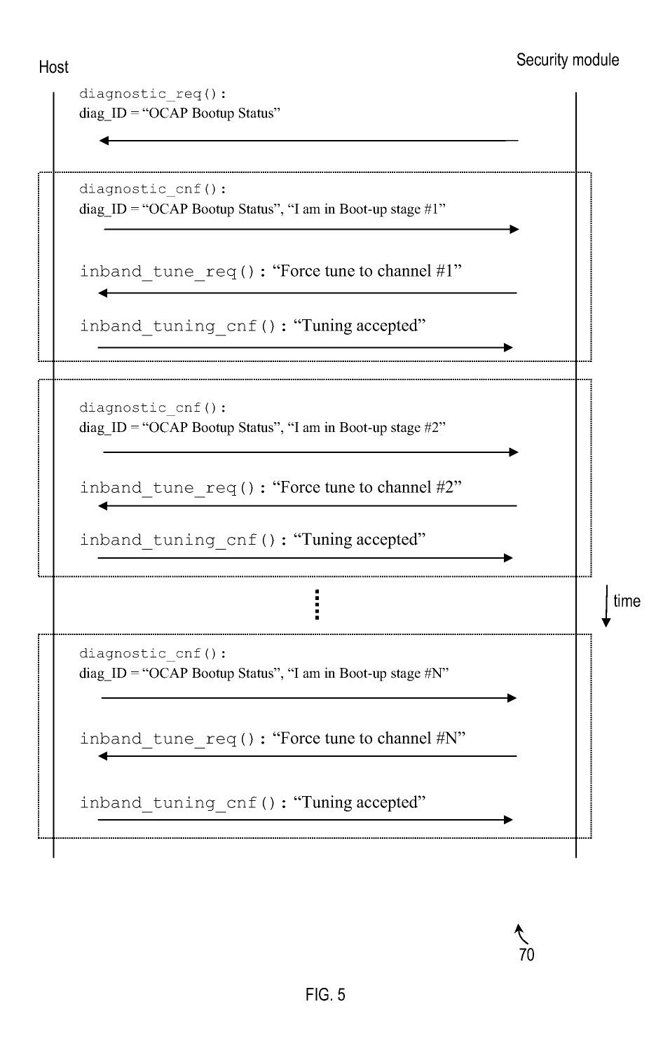

FIG. 5 illustrates example steps for the event detection and notification module 14 reporting boot-up stages and the trigger module 11 force tuning different channels streaming from the MSO 18 based on the boot-up stages, according to an embodiment of the invention. Now also referring to the information exchange event diagram 70 in FIG. 5 in conjunction with FIG. 2, the trigger module 11 may initiate a request of “OCAP Bootup Status” using diagnostic_req( ) APDU, and the event detection and notification module 14 of the OCAP TV 13A performs a diagnostic and responds to the trigger module 11 with status information (e.g., change in the boot-up stage) using a diagnostic_cnf( ). In diagnostic_req( ) APDU, the trigger module 11 uses one of the reserved diagnostic IDs as defined in Table 4 below to request a “OCAP boot-up status” report from the OCAP TV 13A.

TABLE 4
Diagnostic IDs

| Diagnostic IDs | Value |
|---|---|
| Host memory allocation | 0x00 |
| Application version number | 0x01 |
| Firmware version | 0x02 |
| MAC address | 0x03 |
| . . . | . . . |
| Host Information | 0x0E |
| OCAP Bootup Status | 0x0F |
| Reserved | 0xA0-0xFF |

Upon receiving the diagnostic_req( ) APDU from the trigger module 11, the event detection and notification module 14 replies with a diagnostic_cnf( ) APDU as defined in Table 5 below for S-Mode, and Table 6 below for M-Mode, whenever the boot-up stage changes.

TABLE 5
S-Mode - diagnostic_cnf APDU Syntax (Type 1, Version 2)

| Syntax | No. of Bits | Mnemonic |
|---|---|---|
| diagnostic_cnf( ) { | | |
| diagnostic_cnf_tag | 24 | uimsbf |
| length_field( ) | | |
| number_of_diag | 8 | uimsbf |
| for (i=o; i<number_of_diag; i++) { | | |
| diagnostic_id | 8 | uimsbf |
| status_field | 8 | uimsbf |
| if (status_field == 0x00) { | | |
| if (diagnostic_id == 0x00) { | | |
| memory_report( ) | | |
| } | | |
| if (diagnostic_id == 0x01) { | | |
| software_ver_report( ) | | |
| } | | |
| if (diagnostic_id == 0x02) { | | |
| firmware_ver_report( ) | | |
| } | | |
| if (diagnostic_id == 0x03) { | | |
| MAC_address_report( ) | | |
| } | | |
| ... | | |
| if (diagnostic_id == 0x0E) { | | |
| host_information_report( ) | | |
| } | | |
| if (diagnostic_id == 0x0F) { | | |
| OCAP_bootup_report( ) | | |
| } | | |
| } | | |

TABLE 6
M-Mode - diagnostic_cnf APDU Syntax (Type 2, Version 1)

| Syntax | No. of Bits | Mnemonic |
|---|---|---|
| diagnostic_cnf( ) { | | |
| diagnostic_cnf_tag | 24 | uimsbf |
| length_field( ) | | |
| number_of_diag | 8 | uimsbf |
| for (i=o; i<number_of_diag; i++) { | | |
| diagnostic_id | 8 | uimsbf |
| ltsid | 8 | uimsbf |
| status_field | 8 | uimsbf |
| if (status_field == 0x00) { | | |
| if (diagnostic_id == 0x00) { | | |
| memory_report( ) | | |
| } | | |
| if (diagnostic_id == 0x01) { | | |
| software_ver_report( ) | | |
| } | | |
| if (diagnostic_id == 0x02) { | | |
| firmware_ver_report( ) | | |
| } | | |
| if (diagnostic_id == 0x03) { | | |
| MAC_address_report( ) | | |
| } | | |
| ... | | |
| if (diagnostic_id == 0x0E) { | | |
| host_information_report ( ) | | |
| } | | |
| if (diagnostic_id == 0x0F) { | | |
| OCAP_bootup_report( ) | | |
| } | | |
| } | | |
| } | | |
| } | | |

When there are multiple instances of a diagnostic report, the event detection and notification module 14 sends each report with the same diagnostic ID in the diagnostic_cnf( ) APDU. In diagnostic_cnf( ), commonly recognized boot-up stage codes are used between the MSO 18 and TV manufacturer. For example, a set of numbers representing different boot-up stages may be added as shown in Table 7 below for OCAP boot-up stage report.

TABLE 7
OCAP_bootup_report

| Syntax | No. of Bits | Mnemonic |
|---|---|---|
| OCAP_bootup_report( ) { | | |
| bootup_stage | 16 | uimsbf |
| reserved | 16 | uimsbf |
| } | | |

| | |
|---|---|
| bootup_stage | Designates the stage of the HOST during the |
| | OCAP bootup process. The stages of bootup |
| | with or without CableCARD are defined in |
| | section 20.2.1 of OCAP 1.1.1 [OCAP]. |
| | For example, the bootup stages |
| | may be defined as the following. |
| reserved | Reserved for future use. |
| 0x00 | Power Applied or Reboot |
| 0x01 | Hardware and Operating System Initialization |
| 0x02 | Optional: Manufacturer Configuration |
| 0x03 | Initialization of OCAP environment |
| 0x04 | CableCARD/Host Interface Initialization |
| 0x05 | Code Download |
| 0x06 | Load and Parse the XAIT |
| 0x07 | Launch the Initial Monitor Application |
| 0x08 | Launch Auto-start Unbound Applications |
| 0x09 | Configure Environments |
| 0x0A | Begin Normal Operation |

Thus, in response to a OCAP_bootup_status request in the diagnostic_req( )APDU, the event detection and notification module 14 may reply with a OCAP_bootup_report as defined in Table 2 in the diagnostic_cnf( ) APDU.

Alternatively, only the number of OCAP boot-up stages may be provided in the specification. For example, the numbers and the corresponding definition of the OCAP boot-up stages may be specified internally by MSOs and TV manufacturers depending on their requirements and device characteristics.

For the trigger module 11 to force-tune the OCAP TV 13A to MSO-specific content for display on the display 21, a Host Control Resource (specified in sections 9.8.5 and 9.8.6 of CCIF) may be used to force tune inband tuner 22 of the OCAP TV 13A. The trigger module 11 sends an inband_tune_req( ) to the OCAP TV 13A to tune the OCAP TV 13A to a pre-determined inband channel. The trigger module 11 provides inband tuning information to the OCAP TV 13A using a source_id or frequency (with modulation type) for the tuner 22 to tune to. The OCAP TV 13A responds to an inband_tune_req( ) by sending back an inband_tuning_cnf( ) returning with a tune_status (e.g., Tuning accepted). The source_id identifies the MPEG programming source associated with the virtual channel on a system. In this context, a source is one specific source of video, text, data or audio programming. To reference virtual channels to the program guide database, each program is associated with a unique value of source_id.

Before use of source_id is practicable (e.g., due to lack of Service Information (SI) or channel map), a frequency tune type can be used (i.e., tune_type=0x01 from inband_tune_req( )). Therefore, the trigger module 11 may direct the OCAP TV host 13A to force tune to an analog channel using the frequency information. Tuning to a virtual channel may also be possible at this stage if the tuning frequency is provided and a default program number is known to both the security module and the host. Only a frequency value is needed to tune to an analog channel since an analog channel is only associated with the frequency.

After completion of SI download to the OCAP TV host 13A (e.g., stage 11 of the OCAP bootup process), the system may use source ID (i.e., source_id) tune type (i.e., tune_type=0x00, inband_tune_req( )). Upon receiving the source ID from the trigger module 11, the OCAP TV host 13A can determine the frequency and program number from SI by associating the source ID with the frequency and program number. As noted, here may be two implementations for dynamically displaying video/audio from the MSO 18: an asynchronous approach and a synchronous approach as described herein. In either case, an event is associated to each OCAP boot-up stage, enabling the MSO security module 13B to initiate the force tune via the trigger module 11, upon detection of the event sent by the OCAP TV host 13A.

The invention provides enhanced and customized user experience and flexibility for OCAP TV boot-up process, and eliminates the burden on a TV manufacturer to prepare for customized messages and graphics for each MSO network.

The description may disclose several preferred embodiments for customized initialization of host devices in a digital cable network, as well as operation and/or component parts thereof. While the following description will be described in terms of customized initialization of host devices in a cable network for clarity and placing the invention in context, it should be kept in mind that the teachings herein may have broad application to all types of systems, devices and applications, and includes, for example, host devices and networks/systems that are satellite-based, Internet-based, etc. As such, the invention is not limited to cable networks/systems or cable TV networks/systems. Further, the invention is applicable for customized initialization of host devices in information networks that provide one or more of audio, video, data, images, graphics, data streams, and the like, to host devices. In embodiments of the invention, the network (e.g., FIG. 1) may comprise a wired network (e.g., cable network), a wireless network (e.g., satellite-based), or a combination thereof.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specifically defined herein, all terms are to be given their broadest possible interpretation including meanings implied from the specification as well as meanings understood by those skilled in the art and/or as defined in dictionaries, treatises, etc.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Though the present invention has been described with reference to certain versions thereof, however, other versions are possible. Therefore, the spirit and scope of the appended claims should not be limited to the description of the preferred versions contained herein.

What is claimed is:

1. A method of customizing an initialization process for a digital host device, comprising:
triggering an interactive host initialization process for the digital host device, the initialization process including multiple stages;
detecting an initialization stage event for the host device, and providing an initialization stage event notification; and
dynamically receiving content determined by a service provider, over a network based on the initialization stage event notification.

2. The method of claim 1 wherein:
the interactive initialization process further comprises an interactive cable host initialization process for the host device, the host device comprising a digital cable host device and the service provider comprising a Multiple Service Operator (MSO) headend;
triggering an interactive host initialization process further includes triggering an interactive cable host initialization process for the digital cable host device;
detecting an initialization stage event further includes detecting a initialization stage event for the cable host device, and providing an initialization stage event notification; and
dynamically receiving content further includes dynamically receiving content determined by the MSO cable headend over a network based on the initialization stage event notification.

3. The method of claim 2 further comprising:
upon notification of a specified initialization stage event, triggering dynamic delivery of content determined by the MSO headend for the initialization stage event; and
presenting the received content for each initialization stage via the cable host device.

4. The method of claim 3 further comprising:
maintaining a predefined set of initialization stage events and associated content determined by the MSO headend;
upon notification of a specified initialization stage event, selecting an associated content;
dynamically receiving the selected content from a content source over a network; and
presenting the received content via the cable host receiver device for the initialization event.

5. The method of claim 4 further comprising delivering content to the cable host device from the MSO headend via a cable video network based on each initialization stage event notification.

6. The method of claim 5 wherein the interactive cable host initialization process comprises Open Cable Application Protocol (OCAP) initialization process and the cable host device comprises an OCAP cable host receiver device.

7. The method of claim 6 wherein delivering content comprises dynamically tuning the cable host receiver device to a cable channel from the MSO headend based on each initialization stage event notification.

8. The method of claim 7 wherein dynamically delivering content from the MSO headend further comprises approximately synchronizing the content with the cable host receiver device initialization stage.

9. The method of claim 8 further comprising triggering an interactive synchronous initialization process by establishing two way communication between the MSO headend and the cable host receiver device.

10. The method of claim 9 wherein dynamically delivering content from the MSO headend further comprises precisely synchronizing the content with a cable host receiver device initialization stage wherein the cable host receiver device provides initialization stage event notifications to the MSO headend.

11. A method of customizing an interactive cable host initialization process for a cable host device, comprising:
providing a trigger module configured for triggering an interactive cable host initialization process for a digital cable host device;
providing a detection module configured for detecting a initialization stage event for the cable host device and providing an initialization stage event notification to the trigger module;
upon notification of a specified initialization stage event, the trigger module triggering dynamic delivery of selected content determined by an Multiple Service Operator (MSO) headend for the initialization stage event;
the cable host device dynamically receiving the selected content from a content source over a network based on the initialization stage event notification.

12. The method of claim 11 further comprising:
the trigger module maintaining a predefined set of initialization stage events and associated content determined by the MSO headend;
upon notification of a specified initialization stage event, the trigger module triggering dynamic delivery of associated content for the initialization stage event;
the cable host device dynamically receiving said associated content from a content source over a network; and
presenting the received content via the cable host device.

13. The method of claim 11 further comprising:
providing a security module comprising said trigger module;
providing a cable host device comprising said detection module; and
coupling the security module to the cable host device.

14. A system for customizing an interactive cable host initialization process for a cable host device, comprising:
a trigger module configured for triggering an interactive digital cable host initialization process for a digital cable host device; and
a detection module configured for detecting a initialization stage event for the cable host device and providing initialization stage event notification to the trigger module;
wherein the trigger module is further configured such that upon notification of a specified initialization stage event, the trigger module triggers dynamic delivery of content determined by a Multiple Service Operator (MSO) headend for the initialization stage event, to the cable host device over a network.

15. The system of claim 14 wherein:
the trigger module is further configured to maintain a predefined set of initialization stage events and associated content determined by the MSO headend, such that upon notification of a specified initialization stage event, the trigger module selects the associated content for the initialization stage event; and
the cable host device is configured to dynamically receive the selected content from a content source over a network.

16. The system of claim 15 wherein the cable host device receives the selected content from the MSO headend via a cable video network based on each initialization stage event notification.

17. The system of claim 16 wherein the interactive cable host initialization process comprises a tru2way initialization process and the cable host device comprises a tru2way cable host receiver device.

18. The system of claim 17 wherein the interactive cable host initialization process comprises Open Cable Application Protocol (OCAP) initialization process and the cable host device comprises an OCAP cable host receiver device.

19. The system of claim 18 wherein the cable host receiver device is configured to dynamically receive content by: the trigger module dynamically tuning the cable host receiver device to a cable channel from the MSO headend based on each initialization stage event notification.

20. The system of claim 19 wherein content delivery from the MSO headend further comprises approximately synchronizing the content with the cable host receiver device initialization stage.

21. The system of claim 20 wherein the trigger module is further configured for triggering an interactive synchronous initialization process by establishing two way communication between the MSO headend and the cable host receiver device.

22. The system of claim 21 wherein content delivery from the MSO headend further comprises precisely synchronizing the content with the cable host receiver device initialization stage wherein the cable host device provides initialization stage event notifications to the MSO headend.

23. The system of claim 18 wherein the cable host device comprises a cable television receiver.

24. The system of claim 23 wherein the cable host device comprises a set-top-box.

25. The system of claim 14 wherein:
the trigger module is a component of a security module; and
the detection module is a component of the cable host device;
wherein the security module allows viewing of cable television channels without a set-top box.

26. A system for customizing an interactive cable host initialization process for a digital cable host device, comprising:
an Multiple Service Operator (MSO) headend;
a digital cable host device;
a trigger module configured for triggering an interactive digital cable host initialization process for the digital cable host device; and
a detection module configured for detecting an initialization stage event for the cable host device and providing initialization stage event notification to the trigger module;
wherein the trigger module is further configured such that upon notification of a specified initialization stage event, the trigger module triggers dynamic delivery of content determined by the MSO headend for the initialization stage event, to the cable host device over a network.

27. The system of claim 26 wherein the trigger module and the detection module are components of the digital cable host device.

28. The system of claim 26 wherein:
the trigger module is a component of a security module; and
the detection module is a component of the digital cable host device;
wherein the security module allows viewing of cable television channels without a set-top box.

29. A method of customizing an initialization process for a host device, comprising:
determining content for initialization stages of an initialization process for a host device, the initialization process comprising multiple initialization stage events;
dynamically delivering content from a Multiple Service Operator (MSO) headend to the host device based on initialization stage events over a cable network.

30. The method of claim 29 wherein the initialization process comprises:
triggering an interactive host initialization process for the host device;
detecting an initialization stage event for the host device, and providing an initialization stage event notification; and
dynamically receiving content determined by the MSO headend, over the cable network based on the initialization stage event notification.

31. A method of customizing an initialization process for a digital host device, comprising:
a interactive initialization process by a digital host device, the interactive initialization process comprising:
triggering an interactive host initialization process for the digital host device, the initialization process including multiple stages;
detecting an initialization stage event for the host device, and providing an initialization stage event notification; and
dynamically receiving content determined by a service provider, over a network based on the initialization stage event notification.
